(19) United States
(12) Patent Application Publication
(10) Pub. No.: US 2025/0172898 A1
(43) Pub. Date: May 29, 2025

(54) IMAGE FORMING APPARATUS

(71) Applicant: CANON KABUSHIKI KAISHA, Tokyo (JP)

(72) Inventors: MASATO YAMAOKA, Chiba (JP); YASUMASA KIDO, Chiba (JP)

(21) Appl. No.: 18/951,039

(22) Filed: Nov. 18, 2024

(30) Foreign Application Priority Data
Nov. 28, 2023 (JP) 2023-201138

(51) Int. Cl. G03G 15/00

(52) U.S. Cl. CPC G03G 15/6514; G03G 2215/00392; G03G 2215/00544

(57) ABSTRACT

An image forming apparatus includes an image forming unit configured to form an image on a sheet, a tray including a stacking surface on which the sheet is stacked, the tray being configured to be movable between a closed position and an opened position, a sheet feed unit configured to feed the sheet to the image forming unit, an extension tray configured to be movable between an extension position being a position upstream in a sheet feeding direction from the tray and a storage position being a position at which the extension tray is stored in the tray, the sheet being stacked on the extension tray, and an urging member configured to urge the extension tray toward the stacking surface of the tray in a state where the tray is located at the closed position and the extension tray is located at the storage position.

### BACKGROUND

### Field

The present disclosure relates to an image forming apparatus that forms an image on a sheet.

### Description of the Related Art

In recent years, there has been strong demand from customers to reduce an operation noise emitted from image forming apparatuses, such as copying machines and printers. However, an image forming apparatus generates vibrations when operating caused by driving a motor, a gear, and a fan provided in the image forming apparatus. The vibrations are transmitted to various parts of the image forming apparatus, and thus the operation noise is emitted toward a space around the installed position of the image forming apparatus from the inside to the outside of the image forming apparatus.

One of the parts to which the vibrations are transmitted is an exterior cover. Essentially, the exterior cover has a function of insulating the operation noise generated in the image forming apparatus and emitted therefrom toward the outside.

However, the operation noise emitted due to the vibrations of the exterior cover itself is not insulated and directly emitted toward the space around the image forming apparatus.

Accordingly, to achieve a quiet image forming apparatus, it is important to reduce the vibrations of the exterior cover so as not to emit the noise from the exterior cover, i.e., to provide an anti-vibration exterior cover.

The exterior cover includes, as a part of the exterior cover, an open/close type manual sheet feed tray included in a manual sheet feed unit. The manual sheet feed tray becomes a part of the exterior cover by being stored in the apparatus main body of the image forming apparatus when the manual sheet feed tray is not used. Since the surface area of the manual sheet feed tray occupies a relatively large area of the exterior cover, the emitted noise is large when the vibrations are transmitted thereto.

Thus, Japanese Patent Application Laid-Open No. 2009-040555 discusses a configuration that prevents noise generated in the image forming apparatus from transmitting through the manual sheet feed tray and leaking outside by including a noise absorbing material inside the manual sheet feed tray as a noise insulation board.

However, with the configuration in Japanese Patent Application Laid-Open No. 2009-040555, since the noise insulation board is created by arranging the noise absorbing material inside the manual sheet feed tray, the size of the apparatus main body of the image forming apparatus becomes large, and the configuration becomes complicated. As a result, there is a possibility of increased costs and manufacturing loads and reduced space efficiency.

### SUMMARY

The present disclosure is directed to an image forming apparatus with a simple configuration and high space efficiency and with an improved noise reduction performance by preventing vibrations of a manual sheet feed tray.

According to some embodiments, an image forming apparatus includes an image forming unit configured to form an image on a sheet, a tray including a stacking surface on which the sheet is stacked, the tray being configured to be movable between a closed position at which the tray faces a side surface of an apparatus main body including the image forming unit and an opened position at which the tray is opened from the apparatus main body to a position at which the sheet can be stacked, a sheet feed unit configured to feed the sheet stacked on the tray to the image forming unit, an extension tray configured to be movable between an extension position being a position upstream in a sheet feeding direction from the tray and a storage position being a position at which the extension tray is stored in the tray, the sheet being stacked on the extension tray, and an urging member configured to urge the extension tray toward the stacking surface of the tray in a state where the tray is located at the closed position and the extension tray is located at the storage position.

Further features of the present disclosure will become apparent from the following description of exemplary embodiments with reference to the attached drawings.

### BRIEF DESCRIPTION OF THE DRAWINGS

FIG. 1 is a cross-section diagram schematically illustrating an image forming apparatus according to a first exemplary embodiment.

FIG. 2 is a perspective view illustrating a manual sheet feed unit according to the first exemplary embodiment.

FIG. 3 is a diagram illustrating a measurement result of emitted noises from a manual sheet feed tray by using an acoustic camera, according to the first exemplary embodiment.

FIG. 4 is a perspective view illustrating the manual sheet feed tray in a state where an extension tray is pulled out, according to the first exemplary embodiment.

FIG. 5A is a cross-section diagram illustrating the manual sheet feed tray in the state where the extension tray is pulled out, according to the first exemplary embodiment.

FIG. 5B is a cross-section diagram illustrating the manual sheet feed tray in a state where the extension tray is stored, according to the first exemplary embodiment.

FIG. 6 is an expanded perspective view illustrating a vibration suppression configuration according to the first exemplary embodiment.

FIG. 7 is a graph illustrating measurement results of a noise reduction effect of the vibration suppression configuration according to the first exemplary embodiment.

FIG. 8 is a perspective view illustrating the manual sheet feed tray in a state where an extension tray is pulled out, according to a second exemplary embodiment.

FIG. 9A is a cross-section diagram illustrating the manual sheet feed tray in the state where the extension tray is pulled out, according to the second exemplary embodiment.

FIG. 9B is a cross-section diagram illustrating the manual sheet feed tray in a state where the extension tray is stored, according to the second exemplary embodiment.

### DESCRIPTION OF THE EMBODIMENTS

Hereinbelow, various exemplary embodiments, features, and aspects of the present disclosure will be described with reference to the attached drawings. An image forming apparatus according to a first exemplary embodiment is an image forming apparatus of an intermediate transfer type, such as a copying machine, a printer, a facsimile machine, and a combined apparatus thereof, that secondarily transfers a toner image onto a sheet after the toner image is primarily transferred onto an intermediate transfer belt. In the exemplary embodiments described below, the image forming apparatus will be described using the image forming apparatus employing the intermediate transfer method in which four color image forming units are arranged along an intermediate transfer belt.

### Image Forming Apparatus

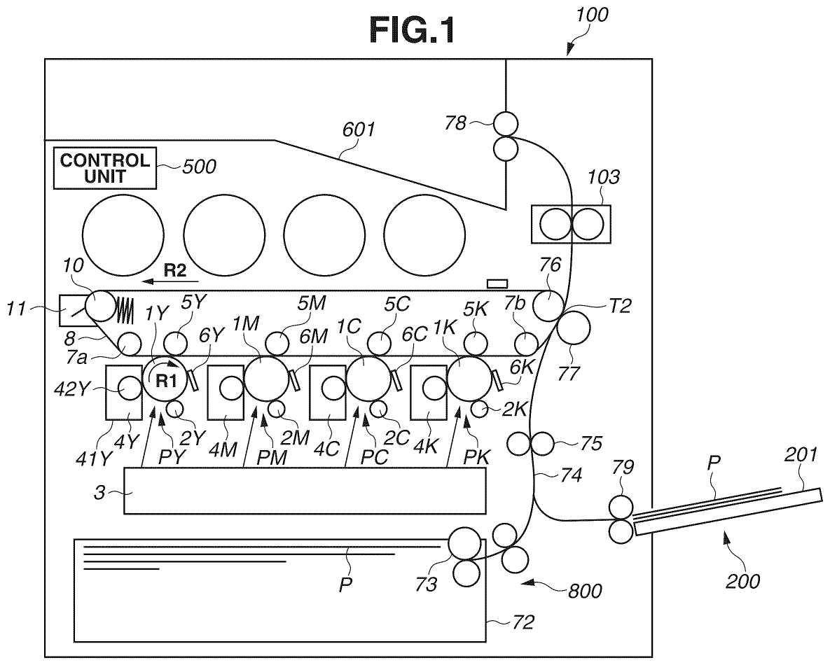

First, with reference to FIG. 1, an image forming apparatus 100 according to the present exemplary embodiment will be described. The image forming apparatus 100 illustrated in FIG. 1 is a color image forming apparatus of an intermediate transfer tandem type in which image forming units PY, PM, PC, and PK of four colors (yellow, cyan, magenta, and black) are arranged in an apparatus main body of the image forming apparatus 100 so as to face an intermediate transfer belt 8 on the lower side of the intermediate transfer belt 8. Examples of a sheet P, which is a recording medium usable by the image forming apparatus 100, include paper sheets such as a plain paper sheet, a thick paper sheet, a rough paper sheet, an uneven paper sheet, and a coated paper sheet, and sheets made of various kinds of materials, such as an overhead projector (OHP) sheet, a plastic film sheet, and a cloth sheet.

The image forming apparatus 100 according to the present exemplary embodiment produces a sheet with a toner image formed thereon as a product, by performing an image forming process in which an image is formed with toner and a sheet conveyance process in which a sheet is conveyed in conjunction with each other.

First, the sheet conveyance process will be described. A cassette sheet feed unit 800 is disposed at a lower part of the image forming apparatus 100, and sheets P are stored in a cassette 72 in a stacked manner. Then, the sheets P are fed toward a conveyance path 74 by a feed roller 73 one by one in synchronization with an image forming timing. Further, a manual sheet feed unit 200 is disposed on a side portion of the image forming apparatus 100. The manual sheet feed unit 200 is provided with a manual sheet feed tray 201, and the sheets P stacked on the manual sheet feed tray 201 are separated one by one by a manual sheet feed roller 79 serving as a feed unit, and the separated sheet P is fed to the conveyance path 74.

The sheet P fed from the cassette sheet feed unit 800 or the manual sheet feed unit 200 is conveyed toward a registration roller 75 disposed midway on the conveyance path 74.

The registration roller 75 performs a skew correction on the conveyed sheet P and an image forming timing correction, and then conveys the sheet P to a secondary transfer portion T2. The secondary transfer portion T2 is a transfer nip portion formed of a secondary inner transfer roller 76 and a secondary outer transfer roller 77 opposing each other.

At the secondary transfer portion T2, a toner image is secondarily transferred from the intermediate transfer belt 8 onto the sheet P.

The image forming process of the image conveyed to the secondary transfer portion T2 at a timing in synchronization with a timing of the sheet conveyance process of the sheet P conveyed to the above-described secondary transfer portion T2 will be described. First, the image forming units PY to PK will be described. The image forming units PY to PK are different only in color of toner used by development devices 4Y, 4M, 4C, and 4K (yellow, magenta, cyan, and black), and have substantially the same configuration. Thus, the image forming unit PY for yellow is described below as a representative example, and descriptions of the other image forming units PM, PC, and PK are omitted. For convenience of illustration, while a developer container 41Y and a developing roller 42Y in the image forming unit PY, to be described below, are indicated by reference numerals, other developer containers and developing roller are not.

The image forming unit PY mainly includes a photoconductive drum 1Y, a charging device 2Y, the development device 4Y, and a photosensitive drum cleaner 6Y. When an image is formed, the photoconductive drum 1Y is driven to rotate in an arrow R1 direction at a predetermined process speed (circumferential speed). A charging voltage is applied to the charging device 2Y from a high-voltage power source, and the surface of the photoconductive drum 1Y is uniformly charged to a predetermined polarity and potential by a current flowing between the charging device 2Y (charging roller) and the photoconductive drum 1Y.

An electrostatic latent image is formed on the photoconductive drum 1Y after being charged, by an exposure with an exposure device 3 based on image information. The electrostatic latent image is developed as a toner image with toner being applied thereto by the development device 4Y. The development device 4Y includes the developer container 41Y containing developer (i.e., toner), and the developing roller 42Y (also referred to as a developing sleeve) bearing the developer and rotating, and develops the electrostatic latent image as a toner image by a development voltage being applied to the developing roller 42Y. Then, a predetermined pressure force and a primary transfer voltage are applied by a primary transfer roller 5Y disposed opposite to the image forming unit PY across the intermediate transfer belt 8, and the toner image formed on the photoconductive drum 1Y is primarily transferred onto the intermediate transfer belt 8. A small amount of transfer residual toner remaining on the photoconductive drum 1Y after a primary transfer is removed by the photosensitive drum cleaner 6Y to prepare for the next image forming process.

The intermediate transfer belt 8 is stretched around a tension roller 10, the secondary inner transfer roller 76, and idler rollers 7a and 7b serving as stretching rollers, and driven to move in an arrow R2 direction in FIG. 1. In the present exemplary embodiment, the secondary inner transfer roller 76 also functions as a driving roller that drives the intermediate transfer belt 8. Image forming processes for respective colors processed by the above-described image forming units PY to PK are performed at timings at which toner images are sequentially superimposed on primarily transferred color toner images having been transferred upstream in a moving direction onto the intermediate transfer belt 8. As a result, a full color toner image is eventually formed on the intermediate transfer belt 8 and conveyed to the secondary transfer portion T2. The transfer residual toner remaining on the intermediate transfer belt 8 after the full color toner image has passed through the secondary transfer portion T2 is removed from the intermediate transfer belt 8 by a transfer residual toner cleaning device 11.

As described above, the conveyance timing of the sheet P and the image forming timing of the full color toner image coincide with each other at the secondary transfer portion T2, through the sheet conveyance process and the image forming process described above, and the toner image is secondarily transferred from the intermediate transfer belt 8 onto the sheet P. Then, the sheet P is conveyed to a fixing device 103, and the toner image transferred onto the sheet P is melted and fixed onto the sheet P by the fixing device 103 pressing and heating the transferred toner image. The sheet P with the toner image fixed thereon is discharged to a discharge tray 601 by a discharge roller 78. The sheet conveyance process and the image forming process are controlled by a control unit 500 provided in the image forming apparatus 100.

### Manual Sheet Feed Tray

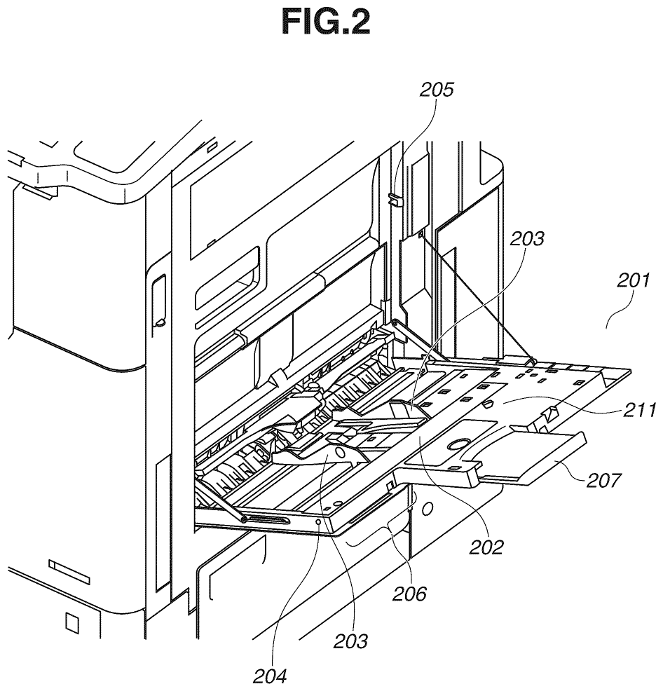

Next, the manual sheet feed tray 201 of the manual sheet feed unit 200 according to the present exemplary embodiment will be described. FIG. 2 is a perspective view illustrating the manual sheet feed tray 201 on which the sheets P are stacked in the manual sheet feed unit 200.

Acrylonitrile butadiene styrene (ABS), which is a kind of resin, is used as a material that forms the manual sheet feed tray 201. Further, the sheets P are stacked on a manual sheet feed tray stacking surface 202 of the manual sheet feed tray 201. On the manual sheet feed tray stacking surface 202 serving as a stacking surface, a pair of side regulating plates 203 is disposed to adjust side edge positions of the sheets P in a width direction orthogonal to a sheet feeding direction. The pair of side regulating plates 203 is movable in conjunction with each other in the width direction of the sheets P so as to match the sheet size. Further, a sheet length detection sensor 211 is provided to detect the length of the sheets P placed on the manual sheet feed tray stacking surface 202.

Further, the manual sheet feed tray 201 is supported by a shaft rotatable with respect to the apparatus main body of the image forming apparatus 100, and can pivot between a storage position, which is a closed position at which the manual sheet feed tray 201 is stored in the apparatus main body when it is not used, and a sheet feeding position, which is an open position at which the manual sheet feed tray 201 is used as illustrated in FIG. 2. Further, a latch mechanism is provided to the manual sheet feed tray 201 and the apparatus main body to hold the manual sheet feed tray 201 at the storage position with respect to the apparatus main body.

On a front side and a back side of the manual sheet feed tray 201, latches 204 are respectively disposed (in FIG. 2, only the latch 204 on the front side is illustrated). Then, latch receptions 205 with holes for respectively engaging with the latches 204 are disposed to parts that face the latches 204 on the front side and the back side of the apparatus main body when the manual sheet feed tray 201 is moved to the storage position of the apparatus main body (in FIG. 2, only the latch reception 205 on the back side is illustrated).

Each of the latches 204 is urged outward by a spring member, and is movable in a direction of the latch reception 205. Each of the latches 204 is engaged with the hole of the latch reception 205 to hold the manual sheet feed tray 201 at the storage position, i.e., the closed position. When the manual sheet feed tray 201 is opened from the storage position to the sheet feeding position, a user puts his or her fingers on a manual sheet feed tray grip portion 206 to pivot the manual sheet feed tray 201. At this time, each of the latches 204 is retracted by the spring member so that each of the latches 204 climbs over a rim of the hole of the latch reception 205, the engagement of the latches 204 and the holes of the latch receptions 205 is released, and the manual sheet feed tray 201 is opened.

The manual sheet feed tray 201 includes an extension tray 207 to be used when the sheets P longer than the size of the manual sheet feed tray 201 in the sheet feeding direction are stacked. The sheet stacking surface can be extended up to an extension position by pulling out the extension tray 207 from the manual sheet feed tray 201 toward an upstream side in the sheet feeding direction. FIG. 2 illustrates a state where the extension tray 207 is pulled out from the manual sheet feed tray 201. When the manual sheet feed tray 201 is closed, the manual sheet feed tray 201 is stored in the apparatus main body in a state where the extension tray 207 is stored in the manual sheet feed tray 201.

### Vibration Generation Source of Manual Sheet Feed Tray

The manual sheet feed tray 201 at the storage position at which the manual sheet feed tray 201 is stored in the apparatus main body is one of the main noise emission sources. Further, the manual sheet feed tray 201 has a play (looseness) due to the open/close mechanism for opening and closing the manual sheet feed tray 201 with respect to the apparatus main body, and vibrations tend to be amplified due to the play.

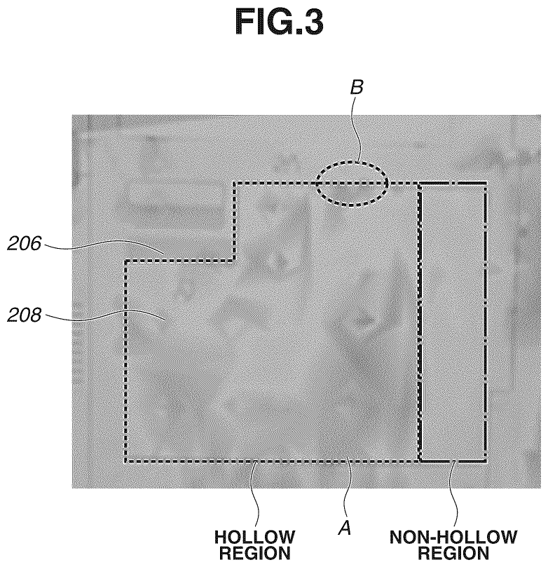

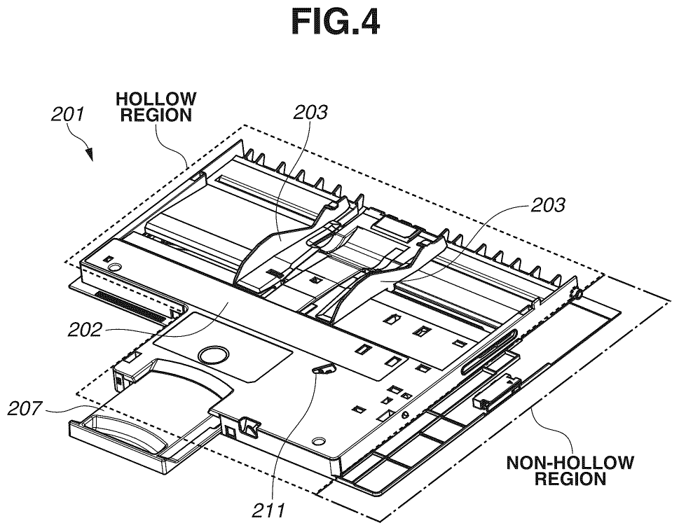

FIG. 3 illustrates a measurement result of measuring, by using an acoustic camera, a noise emitted from the manual sheet feed tray 201 in a state where the extension tray 207 is stored in the manual sheet feed tray 201, and the manual sheet feed tray 201 is closed with respect to the apparatus main body. As a result of the verification by the inventors, when a motor of the sheet feed drive unit for driving and rotating the feed roller 73 provided in the cassette sheet feed unit 800 was operated, vibrations, for example, at 527 hertz (Hz), which was an engagement frequency of gears provided in the sheet feed drive unit, were generated. It became clear that the vibrations were transmitted to the manual sheet feed tray 201 via a fastened portion of the apparatus main body and the manual sheet feed unit 200 to vibrate the manual sheet feed tray 201, and noises were emitted from a manual sheet feed tray outer wall surface 208, which was an outer side surface of the manual sheet feed tray 201. The manual sheet feed tray outer wall surface 208 is a surface opposite to the manual sheet feed tray stacking surface 202. Further, a region A (hollow region) of the manual sheet feed tray outer wall surface 208 in a box shape formed by the manual sheet feed tray stacking surface 202, both side surfaces, and the manual sheet feed tray outer wall surface 208 of the manual sheet feed tray 201 was confirmed as a position where the noise was emitted. In addition, a gap region B, which was included in the region A, where the extension tray 207 and the manual sheet feed tray 201 slid against each other, was also confirmed as a position where the noise was emitted. As illustrated in FIG. 4, the hollow region (region surrounded by a dotted line) in the manual sheet feed tray 201 is a region including a space for storing the extension tray 207 and the sheet length detection sensor 211. In addition, a non-hollow region (region surrounded by a dashed-dotted line) is a region simply covering the surface of the apparatus main body as an exterior cover.

More specifically, it was found that the noise emitted from the manual sheet feed tray 201 included the noise caused by the vibration transmitted from the motor of the apparatus main body, amplified in the hollow region (see FIG. 4) of the manual sheet feed tray 201, and emitted from the manual sheet feed tray outer wall surface 208. In addition, it was found that the noise from the manual sheet feed tray 201 included the noise generated by a vibration being amplified due to the extension tray 207 rattling due to the vibration transmitted to the manual sheet feed tray 201. It was found that the noise from the manual sheet feed tray 201 included these two types of noises.

### Vibration Suppression Configuration of Manual Sheet Feed Tray

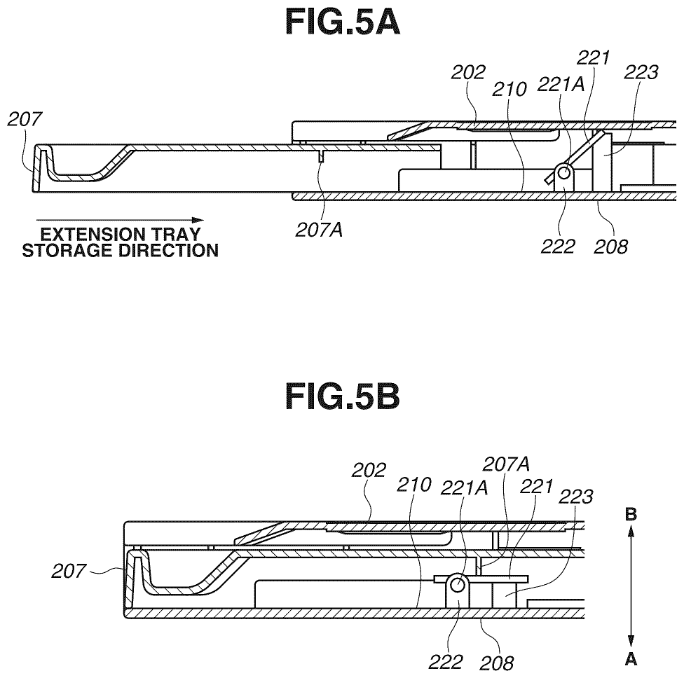

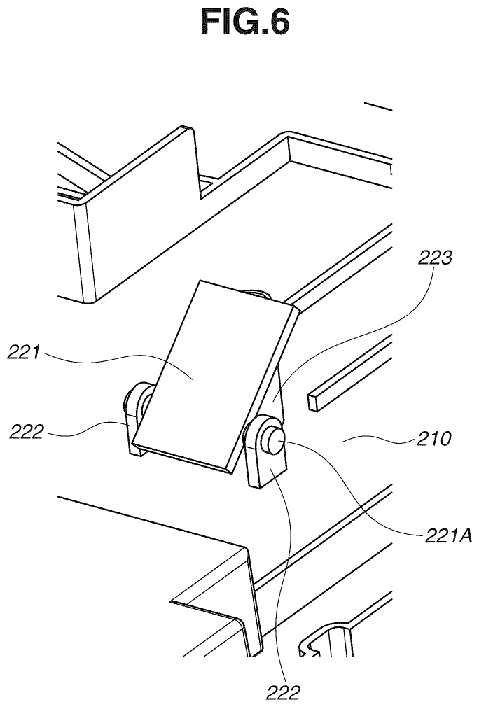

Next, a vibration suppression configuration for reducing the above-described emitted noise will be described. FIGS. 5A and 5B are cross-section diagrams illustrating a vicinity of the extension tray 207 in the manual sheet feed tray 201 according to the present exemplary embodiment. FIG. 5A illustrates a pulled-out state where the extension tray 207 is pulled out from the manual sheet feed tray 201, and FIG. 5B illustrates a storage state where the extension tray 207 is stored in the manual sheet feed tray 201. Further, FIG. 6 is an expanded perspective view illustrating the vibration suppression configuration for applying a vibration suppression force for suppressing the vibrations transmitted to the manual sheet feed tray 201 and the extension tray 207, according to the present exemplary embodiment.

As illustrated in FIGS. 5A, 5B, and 6, in the hollow region between the manual sheet feed tray stacking surface 202 and the manual sheet feed tray outer wall surface 208 of the manual sheet feed tray 201, a vibration suppression member 221 serving as a contact member, an elastic member 223 serving as an urging member, and holding portions 222 are provided. Configurations and effects of these members will be described below.

The vibration suppression member 221 serving as a contact member is a plate-like member having a cylindrical-shape shaft 221A. Further, the holding portions 222 for holding the vibration suppression member 221 are formed on an inner surface 210 of the manual sheet feed tray outer wall surface 208. The holding portions 222 are formed at two positions in a direction perpendicular to a storage direction of the extension tray 207, i.e., in a front-back direction in the drawing surface of FIG. 5 in the present exemplary embodiment. As illustrated in FIG. 6, both ends of the shaft 221A of the vibration suppression member 221 are respectively held by cylindrical-shape holes in the two holding portions 222.

A plate portion of the vibration suppression member 221 is rotatable relative to the manual sheet feed tray 201 and the extension tray 207 by the shaft 221A of the vibration suppression member 221 being supported by the holes of the holding portions 222. Further, the elastic member 223 (a compression spring is used in the present exemplary embodiment) is disposed on a surface of the vibration suppression member 221 opposite to the manual sheet feed tray stacking surface 202 of the manual sheet feed tray 201. One end of the elastic member 223 is fixed to the inner surface 210 of the manual sheet feed tray outer wall surface 208, and the other end is fixed to the vibration suppression member 221. In the state of FIG. 5A, the elastic member 223 is in a compressed state (i.e., resilient state) by the amount of the weight of the vibration suppression member 221 relative to a natural length, and at this time, the vibration suppression member 221 is in an inclined state with respect to the storage direction of the extension tray 207.

From this state, the extension tray 207 moves in the storage direction of the extension tray 207 to be stored in the manual sheet feed tray 201. FIG. 5B illustrates this state.

Along with a storage operation of the extension tray 207, one end of the extension tray 207 is brought into contact with the vibration suppression member 221 to rotate the vibration suppression member 221 around the shaft 221A. By the rotation of the vibration suppression member 221, the elastic member 223 is compressed in an A direction illustrated in FIG. 5B. In the state of FIG. 5B, since the elastic member 223 is in a compressed state in which the length thereof is shorter than the natural length (resilient state), repulsive forces of the elastic member 223 are applied to the vibration suppression member 221 in a B direction and to the inner surface 210 in the A direction, respectively. With this configuration, the repulsive force acting on the inner surface 210 of the manual sheet feed tray outer wall surface 208 acts as a force to suppress a vibration of the manual sheet feed tray outer wall surface 208. Further, the repulsive force applied to the vibration suppression member 221 acts to press the extension tray 207 in the B direction via a contact portion 207A disposed on the extension tray 207 that prevents the rotation of the vibration suppression member 221. Accordingly, with the repulsive force acting on the vibration suppression member 221, a play of the extension tray 207 with respect to the manual sheet feed tray 201 can be reduced.

With the above-described vibration suppression configuration, in the state where the extension tray 207 is stored in the manual sheet feed tray 201 and where the manual sheet feed tray 201 is closed with respect to the apparatus main body, it is possible to suppress both the vibration of the manual sheet feed tray outer wall surface 208 and the play of the extension tray 207. In this way, since a vibration can be suppressed before the vibration transmitted from the apparatus main body is emitted from the manual sheet feed tray outer wall surface 208 as a noise, it is possible to reduce an operation noise emitted outside. Further, it is also possible to prevent generation of a noise generated due to the play between the manual sheet feed tray 201 and the extension tray 207.

In the present exemplary embodiment, the diameter of the elastic member 223 was set to φ6 mm, and the repulsive force was set to 0.5 N, but these values are desirably adjusted in consideration of the space, the load desired to prevent the vibration and the play, and the usability of the extension tray pull-out operation force. Further, to use the extension tray 207 again, a user only needs to pull out the extension tray 207 in a direction opposite to the storage direction of the extension tray 207, and the usability does not change depending on whether the configuration according to the present exemplary embodiment is used. Thus, the user can just obtain the noise reduction effect without any inconvenience.

Next, the noise reduction effect of the above-described vibration suppression configuration will be described. In a state where the manual sheet feed tray 201 according to the present exemplary embodiment was stored in the image forming apparatus 100, the sound pressure level (unit: decibel (dB)) of the operation noise when a sheet feeding/driving motor is driven to rotate was measured.

A microphone that detects an emitted acoustic wave and converts the detected acoustic wave into an electrical signal was used for the measurement. A pre-amplifier that amplifies the electrical signal, and an arithmetic apparatus that calculates the amplified electrical signal into a sound pressure level and a frequency were connected to the microphone. The detection surface of the microphone was arranged at a position opposing a center portion of the right surface side of the image forming apparatus 100 where the manual sheet feed tray 201 was disposed, at a distance of 1 m (meter) from the exterior surface of the image forming apparatus 100 and a height of 1.5 m from the floor surface.

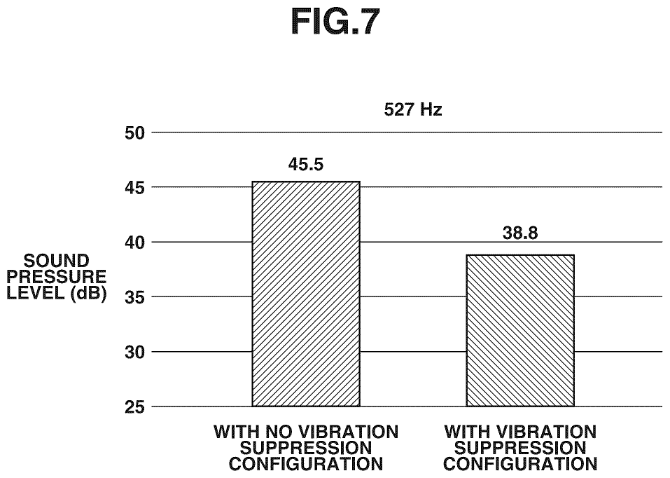

FIG. 7 is a graph illustrating measurement results of the sound pressure level. In the graph, the measurement results of cases where no vibration suppression configuration is provided and where the vibration suppression configuration according to the present exemplary embodiment is provided are illustrated. With the vibration suppression configuration provided, it was confirmed that the operation noise at 527 Hz, which was a frequency generated due to gear engagement in the sheet feed drive unit, was reduced by about 7 dB.

In the present exemplary embodiment, only one vibration suppression configuration is provided, but a plurality of vibration suppression configurations may be provided at a plurality of positions as desired. Further, in the present exemplary embodiment, the extension tray 207 directly rotates the vibration suppression member 221, but a link mechanism may be separately provided. With the link mechanism therebetween, the vibration suppression configuration can be employed when the vibration at a position away from the extension tray 207 is desired to be suppressed. Further, the compression spring is used as the elastic member 223 in the present exemplary embodiment, but any member can be used as long as the member can apply the repulsive forces to the manual sheet feed tray 201 and the extension tray 207, for example, a torsional spring, a rubber, and a resin spring. Further, in the present exemplary embodiment, the configuration in which the extension tray 207 is stored inside the manual sheet feed tray 201 is described, but a configuration in which the extension tray 207 moves on a slide rail on the surface of the manual sheet feed tray 201 and is stored on the surface of the manual sheet feed tray 201 in an overlapped manner may be employed.

The extension tray 207 according to the first exemplary embodiment has the configuration in which the extension tray 207 is linearly slid and pulled out from the manual sheet feed tray 201, but the extension tray 207 according to a second exemplary embodiment has a configuration in which the extension tray 207 has a rotation shaft at one end of the extension tray 207, the rotation shaft is held by the manual sheet feed tray 201, and the extension tray 207 rotates around the rotation shaft.

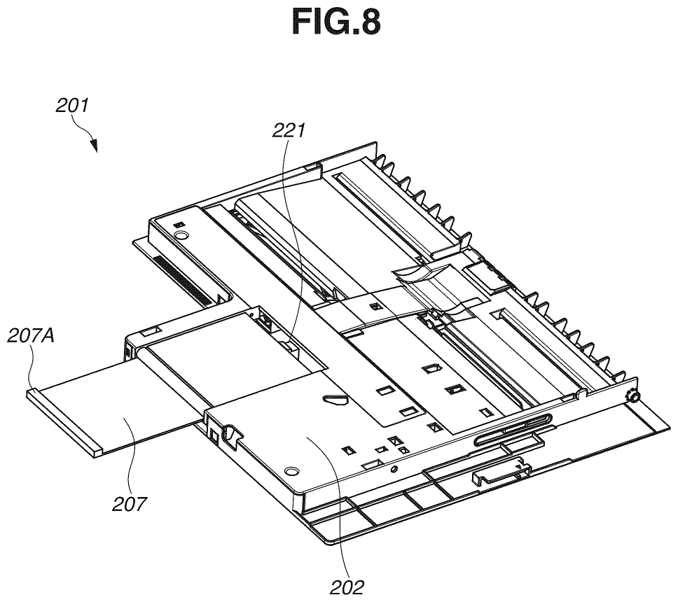

FIG. 8 is a perspective view illustrating the manual sheet feed tray 201 according to the present exemplary embodiment. FIG. 8 illustrates a state where the extension tray 207 is pulled out. In this state, the extension tray 207 can be switched between the storage state and the pulled-out state by rotating the extension tray 207 with respect to the manual sheet feed tray 201. The storage state is a state where the extension tray 207 is stored in the manual sheet feed tray 201. The pulled-out state is a state where the extension tray 207 is pulled out from the manual sheet feed tray 201. In the present exemplary embodiment, the extension tray 207 is brought into contact with a contact member of the manual sheet feed tray 201 to become the pulled-out state, in a state where the extension tray 207 is rotated 180° with respect to the manual sheet feed tray 201 from the storage state.

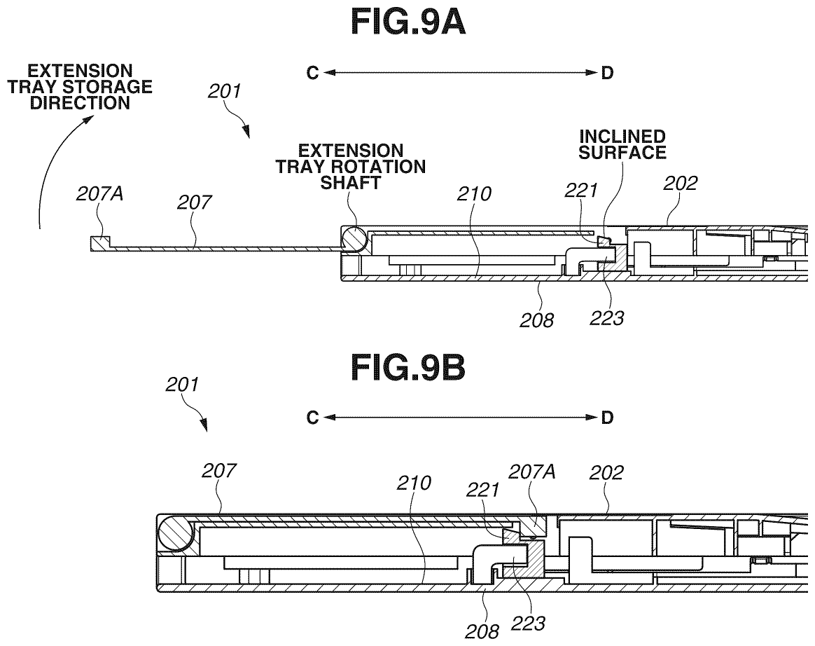

Next, with reference to FIGS. 9A and 9B, a configuration of the manual sheet feed tray 201 according to the present exemplary embodiment will be described in detail. FIG. 9A is a cross-section diagram illustrating the manual sheet feed tray 201 in the state where the extension tray 207 is pulled out from the manual sheet feed tray 201, and FIG. 9B is a cross-section diagram illustrating the manual sheet feed tray 201 in the state where the extension tray 207 is stored in the manual sheet feed tray 201.

In the present exemplary embodiment, one end of the elastic member 223 is held by a holding portion of the inner surface 210 of the manual sheet feed tray outer wall surface 208, and the other end thereof is held by the vibration suppression member 221. The vibration suppression member 221 is provided so as to be movable in C and D directions in FIGS. 9A and 9B, and as illustrated in FIG. 8, a part of the vibration suppression member 221 is exposed on the outside from the manual sheet feed tray stacking surface 202 of the manual sheet feed tray 201. Further, the part exposed from the manual sheet feed tray stacking surface 202 of the vibration suppression member 221 has an inclined surface. The angle of the inclined surface is set at an angle, when a force is applied from above onto the inclined surface so as to convert the force into a force that presses the vibration suppression member 221 in the C direction. At this time, the vibration suppression member 221 does not protrude beyond the manual sheet feed tray stacking surface 202 so as not to hinder the sheet stacking.

Further, in the present exemplary embodiment, the elastic member 223 is held on a side surface of the vibration suppression member 221, which is perpendicular to the inner surface 210 of the manual sheet feed tray outer wall surface 208, and the vibration suppression member 221 can move in the C and D directions in FIGS. 9A and 9B by expansion and contraction of the elastic member 223. In this way, the elastic member 223 is held in a state bent 90° in the present exemplary embodiment. In the present exemplary embodiment, a metal compression spring is used for the elastic member 223. Further, a stopper is disposed on the vibration suppression member 221 to prevent the movement in a direction perpendicular to the C and D directions. In addition, in the state of FIG. 9A, the elastic member 223 substantially has the natural length. When the extension tray 207 is rotated around an extension tray rotation shaft from the state in FIG. 9A in a storage direction of the extension tray 207, the contact portion 207A of the extension tray 207 is brought into contact with the inclined surface of the vibration suppression member 221. Further, when the extension tray 207 is rotated toward the storage position, the vibration suppression member 221 receives a force in the C direction from the contact portion 207A via the inclined surface. With this force, the vibration suppression member 221 moves in the C direction while compressing the elastic member 223. Then, when the extension tray 207 moves to the storage position, the contact portion 207A comes off the inclined surface to be in a state of contacting the side surface of the vibration suppression member 221. FIG. 9B illustrates this state.

In the state of FIG. 9B, since the elastic member 223 is compressed to be shorter than the natural length, the repulsive force of the elastic member 223 is acting on the vibration suppression member 221 in the D direction, and the repulsive force is acting on the inner surface 210 of the manual sheet feed tray 201 in a vertical direction thereto. Further, since the vibration suppression member 221 and the contact portion 207A are in contact with each other, an urging force is also acting on the extension tray 207 in the D direction. Thus, in the state where the extension tray 207 is stored, the extension tray 207 is pressed to one side by the repulsive force of the elastic member 223 applied to the extension tray 207 to prevent the play, and accordingly to prevent the vibration. As a result, the amplification of the operation noise is prevented. Further, since the repulsive force is also applied to the inner surface 210 of the manual sheet feed tray 201, the noise emitted outside is expected to be reduced by vibration of the manual sheet feed tray outer wall surface 208 being suppressed. In addition, in a case where a portion including the inner surface 210 and the manual sheet feed tray outer wall surface 208 in the manual sheet feed tray 201 is referred to as an outer side portion, in the present exemplary embodiment, as described above, the vibration suppression member 221 and the elastic member 223 are disposed between the outer side portion and the extension tray 207.

In the present exemplary embodiment, a compression spring is used as the elastic member 223, but another elastic member, such as a plate spring, a torsion spring, and a rubber, may be used since the repulsive forces only need to be applied to the extension tray 207 and the manual sheet feed tray outer wall surface 208 (i.e., the outer side portion). Further, the vibration suppression member 221 moves in the C direction, but the vibration suppression member 221 may move in the D direction. Further, the vibration suppression mechanism including the elastic member 223 may be disposed on the extension tray 207, not on the inner surface 210 of the manual sheet feed tray outer wall surface 208. However, since the vibration suppression mechanism may hinder the sheet stacking when the extension tray 207 is pulled out in the case where the vibration suppression mechanism is disposed on the extension tray 207, the vibration suppression mechanism may desirably be disposed on the inner surface 210 of the manual sheet feed tray outer wall surface 208 as in the present exemplary embodiment.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2023-201138, filed Nov. 28, 2023, which is hereby incorporated by reference herein in its entirety.

What is claimed is:

1. An image forming apparatus comprising:
an image forming unit configured to form an image on a sheet;
a tray including a stacking surface on which the sheet is stacked, the tray being configured to be movable between a closed position at which the tray faces a side surface of an apparatus main body including the image forming unit and an opened position at which the tray is opened from the apparatus main body to a position at which the sheet can be stacked;
a sheet feed unit configured to feed the sheet stacked on the tray to the image forming unit;
an extension tray configured to be movable between an extension position being a position upstream in a sheet feeding direction from the tray and a storage position being a position at which the extension tray is stored in the tray, the sheet being stacked on the extension tray; and
an urging member configured to urge the extension tray toward the stacking surface of the tray in a state where the tray is located at the closed position and the extension tray is located at the storage position.

2. The image forming apparatus according to claim 1,
wherein the urging member includes a contact member configured to contact the extension tray, and an elastic member configured to urge the contact member toward the stacking surface of the tray, and
wherein the contact member contacts the tray in a state where the extension tray is located at the extension position, and the contact member contacts the extension tray in a state where the extension tray is located at the storage position.

3. The image forming apparatus according to claim 2,
wherein the contact member is rotatably provided on the tray, and
wherein a rotation center shaft of the contact member is orthogonal to a conveyance direction.

4. The image forming apparatus according to claim 1, wherein the extension tray is drawable with respect to the tray toward an upstream side in the sheet feeding direction.

5. An image forming apparatus comprising:
an image forming unit configured to form an image on a sheet;
a tray including a stacking surface on which the sheet is stacked, the tray being configured to be movable between a closed position at which the tray is closed along a side surface of an apparatus main body including the image forming unit and an opened position at which the tray is opened from the apparatus main body to a position at which the sheet can be stacked;
a sheet feed unit configured to feed the sheet stacked on the tray to the image forming unit;
an extension tray configured to be rotatable between an extension position being a position upstream in a sheet feeding direction from the tray and a storage position being a position at which the extension tray is stored in the tray, the sheet being stacked on the extension tray; and
an urging member disposed between the tray and the extension tray and configured to urge the extension tray in the sheet feeding direction in a state where the extension tray is located at the storage position.
